(19) United States
(12) Patent Application Publication
(10) Pub. No.: US 2026/0356302 A1
(43) Pub. Date: Nov. 12, 2026

(54) ASSEMBLY FOR RECEIVING AT LEAST ONE DISPLAY DEVICE

(71) Applicant: Valeo Comfort and Driving Assistance, Créteil (FR)

(72) Inventor: Stephane Dalmayrac, Créteil (FR)

(73) Assignee: Valeo Comfort and Driving Assistance, Créteil (FR)

(21) Appl. No.: 19/135,066

(22) PCT Filed: Nov. 21, 2023
(86) PCT No.: PCT/EP2023/082617

§ 371 Date: Jun. 2, 2025

(30) Foreign Application Priority Data
Dec. 2, 2022 (FR) FR2212696

(51) Int. Cl. B60R 11/02; B60R 11/00

(52) U.S. Cl. CPC B60R 11/0235; B60R 2011/0005; B60R 2011/0066

(57) ABSTRACT

Described is an assembly for receiving a display device. The assembly includes a façade made of a glass material with a first coefficient of expansion, which is designed to be placed in front of the display device, and a support made of a metal material with a second coefficient of expansion. The second coefficient of expansion is higher than the first coefficient of expansion. The support is designed to support the façade and is formed by a succession of portions positioned in a main direction of expansion of the assembly. An adhesive secures the façade on the portions of support.

The present invention relates to an assembly for receiving at least one display device comprising a façade and a support. The invention also relates to a method for assembling an assembly of this type.

In a known manner, an assembly exists which is designed to receive a display device comprising one or more screens extending over the entire width of the instrument panel of a vehicle. This display device is behind a façade of the assembly, which for example is made of glass. The façade is supported by a support of the assembly, which for example is made of metal. The securing between the façade and the support is ensured by an adhesive.

When the assembly is submitted to strong variations of temperature, the adhesive which is used to secure the façade on the support is subjected to shearing that can damage the adhesive, which is undesirable.

The objective of the present invention is in particular to remedy this drawback.

The subject of the invention is thus an assembly which is designed to receive at least one display device, and comprising:
a façade made of a first material with a first coefficient of expansion, in particular glass, which is designed to be placed in front of said display device;
a support made of a second material with a second coefficient of expansion, in particular metal, this second coefficient of expansion being higher than the first coefficient of expansion, said support being designed to support the façade, and said support being formed by a succession of at least two portions of support positioned in a main direction of expansion of the assembly; and
at least one adhesive which secures the façade on the portions of support.

Thus, each of the portions of support is able to expand in the main direction of expansion. Since each portion of support has a dimension which is reduced in relation to the total dimension of the support, the value of the expansion of the support is reduced.

By this means, the differential expansion between the façade and the support is reduced in the main direction of expansion of the assembly, which has the effect of limiting the shearing of the adhesive which secures the façade on the support in this direction.

For example, when the support is formed by a succession of at least two portions of support, the shearing of the adhesive is divided by half.

“The main direction of expansion of the assembly” means a particular direction in which the expansion or contraction of the different parts of the assembly is measured. It will be appreciated that the expansion can take place in other directions. Hereinafter, account is not taken of the expansions which take place in these other directions.

“Succession of at least two portions of support” means the fact that these portions of support are placed in the main direction of expansion one after another. For example, these portions of support are aligned in this main direction of expansion.

According to one of the aspects of the invention, the portions of support are positioned with a space between them in the main direction of expansion of the assembly.

Thus, the space between the portions of support makes it possible to prevent damage or friction noises or squeaking caused by any contact between the portions of support.

According to one of the aspects of the invention, the assembly comprises a cradle, in particular made of metal, which is designed to be secured in a rigid manner on the façade, in particular by means of an adhesive. The adhesive can be the same as that used to secure the façade on the portions of support.

“Secured in a rigid manner” means the fact that there is no degree of freedom between the cradle and the façade. The cradle makes it possible to render the portions of support integral, while leaving them a degree of freedom in the main direction of expansion of the assembly, such as to allow the portions of support to slide along the cradle as the expansion takes place.

According to one of the aspects of the invention, the cradle comprises:
a securing element which is designed to be secured on the façade; and
a base which is integral with the securing element, with said base supporting the portions of support.

The cradle also defines an interface for fitting of the assembly in a vehicle. This cradle also comprises elements which are configured for its positioning and securing in the vehicle.

According to one of the aspects of the invention, the portions of support are interposed between the cradle and the façade.

According to one of the aspects of the invention, the cradle base is configured to support the portions of support with a degree of freedom which allows the portions of support to slide in relation to the cradle in the main direction of expansion.

According to one of the aspects of the invention, the cradle base has a periphery which is substantially rectangular.

It will be appreciated that any other form of periphery can be envisaged, for example a periphery with a polygonal, elliptical, circular form, etc.

According to one of the aspects of the invention, the securing element and the cradle base form a part in a single piece, or form distinct parts which are assembled. In general, the cradle can be produced in several possible manners.

According to one of the aspects of the invention, the cradle has a plane of symmetry which passes via a middle of this cradle in the main direction of expansion.

According to one of the aspects of the invention, the securing element is situated on the median plane of symmetry of the façade in the main direction of expansion.

Thus, the securing element permits referencing of the façade in relation to the vehicle.

According to one of the aspects of the invention, the façade has a substantially rectangular form, with the large side of the rectangle extending in the main direction of expansion.

This form, which is substantially rectangular, can be perfectly rectangular, or have rounded corners.

According to one of the aspects of the invention, each portion of support faces a part of the façade.

According to one of the aspects of the invention, the portions of support face different parts of the façade, such that all the portions of the support together face this façade.

According to one of the aspects of the invention, the assembly comprises at least one sliding connection which is configured to connect the cradle and one of the portions of support, such as to permit translation of the portion of support with respect to the cradle in the main direction of expansion.

According to one of the aspects of the invention, the assembly comprises a sliding connection for each of the portions of support.

The rigidity of the assembly is provided by the cradle. The cradle renders the portions of support integral, while leaving a degree of freedom, thanks to the sliding connections in the main direction of expansion of the assembly, such as to allow the portions of support to slide along the cradle as the expansion takes place.

According to one of the aspects of the invention, the assembly comprises at least one pivot-sliding connection.

According to one of the aspects of the invention, the pivot-sliding connection device comprises a guiding element which is designed to cooperate with one of the portions of support.

According to one embodiment of the invention, the guiding element is movable relative to the securing element.

According to another embodiment of the invention, the guiding element is immobile relative to the securing element.

According to one of the aspects of the invention, one of the portions of support comprises a hollow small column extending along a perpendicular axis of the portion of support. This hollow small column is part of the pivot-sliding connection device.

According to one of the aspects of the invention, at least one of the pivot-sliding connection devices comprises a runner which forms the immobile guiding element.

Said runner permits sliding in the main direction of expansion.

According to one of the aspects of the invention, the guiding element comprises an orifice, designed to receive the small column which can extend in said orifice.

According to one of the aspects of the invention, the runner comprises an orifice, designed to receive the small column which can extend in said orifice.

According to one of the aspects of the invention, the orifice has an oblong form in the main direction of expansion.

According to one of the aspects of the invention, the dimensions of the orifice of the guiding element are selected such as to permit clearance of the small column in the main direction of expansion of the assembly.

According to one of the aspects of the invention, the runner is integral with the cradle or with the portions of support.

According to one of the aspects of the invention, the runner is embedded in the cradle base.

According to one of the aspects of the invention, at least one of the pivot-sliding connection devices comprising at least one main blocking element extends on an axis perpendicular to the portion of support.

According to one of the aspects of the invention, the main blocking element is positioned in the hollow small column of the portion of support.

According to one of the aspects of the invention, the pivot-sliding connection device also comprises at least two secondary blocking elements which are embedded in the cradle base and the runner along an axis perpendicular to the cradle base.

According to one of the aspects of the invention, the axis perpendicular to the base of the cradle and the axis perpendicular to the portion of support coincide with one another.

According to one of the aspects of the invention, each blocking element is designed to cooperate with a runner.

According to one of the aspects of the invention, the securing element is designed to cooperate with a runner.

According to one of the aspects of the invention, the blocking element is formed by at least one out of the following assembly means: screws and bolts, a rivet.

According to one of the aspects of the invention, the blocking element consists of screws and bolts comprising at least one screw.

According to one of the aspects of the invention, the head of the screw is wider than the orifice of the runner.

According to one of the aspects of the invention, the pivot-sliding connection comprises:
the main blocking element positioned in the hollow small column; and
at least the two other secondary blocking elements embedded in the cradle base and the runner, in the direction opposite the main blocking element, such that the runner is interposed between the main blocking element and the secondary blocking elements.

By this means, the runner is secured on the cradle base in an optimal manner as a result of the stresses applied in the two opposite directions by the main and secondary blocking elements. Assembly can also be carried out by clipping in the place of the main and secondary blocking elements.

According to one of the aspects of the invention, each sliding connection comprises at least two pivot-sliding connection devices which are associated in such a way as to maintain a degree of freedom in translation in the main direction of expansion.

By being arranged in an appropriate manner, these pivot-sliding connection devices make it possible to block any rotation.

According to one of the aspects of the invention, the pivot-sliding connection devices are spaced from one another in the direction of the expansion of the assembly.

According to one of the aspects of the invention, each portion of support comprises at least two pivot-sliding connection devices which are offset from one another on an axis transverse to the main direction of expansion of each portion of support.

These pivot-sliding connection devices make it possible to reinforce the assembly and prevent the hinge effect.

According to one of the aspects of the invention, the pivot-sliding connection devices are a multiple of two, i.e. at least two, and preferably four, on each portion of support.

According to one of the aspects of the invention, the pivot-sliding connection devices are positioned along the main direction of expansion of the assembly.

According to one of the aspects of the invention, the pivot-sliding connection devices are positioned on the portions of support symmetrically in relation to a median plane of symmetry of the façade.

According to one of the aspects of the invention, the runner is made of plastic or polymer, with a low coefficient of friction in relation to the coefficient of friction of the second material which forms the portions of support, in particular polymer derived from tetra-fluoroethylene.

Thus, the runner made of plastic or polymer makes it possible to reduce the friction between the materials, for example the metal, having a coefficient of friction which is higher than the coefficient of friction of the material which forms the runner. This is the case in particular when the runner is inserted between the cradle and the portions of support made of metal.

According to one of the aspects of the invention, the runner is integral with the securing element by being screwed into the cradle, adhesion or over-molding of the runners by plastic injection.

According to one of the aspects of the invention, each portion of support is designed such as to cooperate with the pivot-glide connection devices which are positioned alternating in the main direction of expansion of the assembly.

According to one of the aspects of the invention, each portion of support is designed to cooperate with at least the three pivot-sliding connection devices.

According to one aspect of the invention, the cradle base comprises:
a plurality of notches, designed to permit the insertion of hooks belonging to one of the portions of support; and
these hooks of the portion of support being designed to render the portion of support integral with the cradle base, while leaving a degree of freedom of translation in the main direction of expansion, when the portion of support is assembled with the cradle base.

In order to assemble the portion of support on the cradle base, the hooks are inserted in the notches, then the portion of the support is slid in relation to the cradle base, such that the hooks are engaged with the cradle base, while leaving the degree of freedom of translation in the main direction of expansion.

According to one of the aspects of the invention, each sliding connection comprises a pivot-sliding connection device and at least two hooks positioned on two parallel lateral edges of the portion of support, such as to maintain a degree of freedom in translation in the main direction of expansion.

According to one of the aspects of the invention, the assembly comprises two stops in order to limit the displacement of the portion of support in relation to the cradle base, while permitting a degree of translation of a value equal to the maximal expansion or more.

According to one of the aspects of the invention, each portion of support comprises at least one stop in order to limit the displacement of the portion of the support in relation to the cradle base, while permitting a degree of translation with a value equal to the maximal expansion or more.

According to one of the aspects of the invention, the stops are formed on the pivot-sliding connection device The stops correspond to the ends of the oblong orifices.

According to one of the aspects of the invention, said notches are positioned on each lateral edge of the cradle, said lateral edge of the cradle being parallel to the longest length of the cradle.

According to one of the aspects of the invention, the assembly comprises a slide interposed between the hooks and one of the portions of support, such that the cradle can slide in the main direction of expansion, between the hooks and one of the portions of the support, with less friction.

According to one of the aspects of the invention, the slide comprises a guiding rib, which is designed to cooperate with a groove of the cradle, said rib extending in the main direction of expansion of the assembly.

The guiding rib allows one of the portions of support to slide in the main direction of expansion along the cradle as the thermal expansion takes place.

According to one of the aspects of the invention, the runner is integral with one of the portions of support.

The movement of the sliding of the cradle takes place between the cradle and the runner which is integral with one of the portions of support.

According to one of the aspects of the invention, the guiding rib is situated on the plane of axial symmetry of the longest length of the runner.

According to one of the aspects of the invention, the two portions of support are symmetrical with one another in relation to a plane of symmetry which intersects perpendicularly the main direction expansion of the assembly.

According to one of the aspects of the invention, the two portions of support are symmetrical with one another in relation to a median plane of symmetry of the longest length of the façade.

According to one of the aspects of the invention, the adhesive which is used to secure the façade on the portions of support is situated on the periphery of each portion of support.

According to one of the aspects of the invention, the façade forms a plate.

According to one of the aspects of the invention, the portions of support have dimensions which are identical to one another.

According to one of the aspects of the invention, the lengths of each portion of support are identical to one another.

According to one of the aspects of the invention, the dimensions of the support are smaller than, or the same as, the dimensions of the façade.

According to one of the aspects of the invention, the support is invisible from the side of the façade.

According to one of the aspects of the invention, a protection unit can be added to the periphery of the assembly.

Thus, the additional protection unit makes it possible to complete the esthetic appearance of the assembly, in particular at the border. In addition, this protection unit makes it possible to provide better protection for the periphery of the assembly, in particular at the edges of the façade, which for example is made of glass.

According to one of the aspects of the invention, the façade is made in a single piece.

According to one of the aspects of the invention, the main direction of expansion is the direction of the longest length of the assembly.

According to one of the aspects of the invention, the façade is transparent, such that the image of the display device can be seen through this façade.

According to one of the aspects of the invention, the first material is made of glass, in particular tempered glass.

The glass has good dimensional properties, in particular in terms of the levelness and the tautness of the surface, which is favorable for the optical functionality of the object which it covers. The glass can easily be treated by a coating which improves its optical characteristics, in particular terms of the reflectivity. The glass is also rigid, and has good resistance to scratching.

According to one of the aspects of the invention, the second material is a metal selected from among a magnesium alloy or an aluminum alloy.

The magnesium alloy has optimal mechanical properties in relation to its density, and the aluminum alloy has a satisfactory modulus of elasticity.

According to one of the aspects of the invention, the portion of support is produced by molding under pressure.

This production method provides great geometric possibilities for obtaining good strength in relation to the volume of material used, in particular in order to produce ribs, and good levelness.

According to one of the aspects of the invention, the adhesive is a glue seal, a double-face adhesive, a bi-component glue, a silicon glue, a mastic.

According to one of the aspects of the invention, the façade is secured on the portions of support and on the securing element of the cradle.

The subject of the invention is also a module, in particular a vehicle instrument panel, comprising an assembly according to the invention and a display device positioned facing the façade of the assembly.

According to one of the aspects of the invention, the display device comprises a plurality of screens.

According to one of the aspects of the invention, the display device comprises a single screen.

According to one of the aspects of the invention, each screen comprises a panel of pixels.

According to one of the aspects of the invention, the size of the screens is 10.25 inches or 12.3 inches with an image format of 8:3.

According to one of the aspects of the invention, the screens are arranged such as to extend across the entire width of an instrument panel of a vehicle.

According to one of the aspects of the invention, the width of an instrument panel of a vehicle measures at least 0.8 m, preferably at least 1.2 m, and more particularly between 1.2 and 1.4 m.

The subject of the invention is also a method for production of the assembly designed to receive at least one display device as claimed in any one of the preceding claims, said method comprising the following steps:
providing a façade made of a first material having a first coefficient of thermal expansion, in particular glass, designed to be placed in front of said display device;
providing a support made of a second material having a second coefficient of thermal expansion, in particular metal, this second coefficient of thermal expansion being higher than the first coefficient of thermal expansion, and said support being designed to support the façade, and said support being formed by a succession of at least two portions of support positioned in a main direction of expansion of the assembly in a main direction of expansion of the assembly; and
securing the façade on the portions of support with at least one adhesive.

According to one of the aspects of the invention, the method also comprises the following steps:
providing a cradle comprising:
   a securing element designed to be secured on the façade; and
   a base integral with the securing element, said base supporting the portions of support;
securing the façade on the portions of support and on the securing element.

Other characteristics, details and advantages of the invention will become more clearly apparent on reading the detailed description provided below, and from a plurality of embodiments provided by way of non-limiting indication, with reference to the appended schematic drawings, in which:

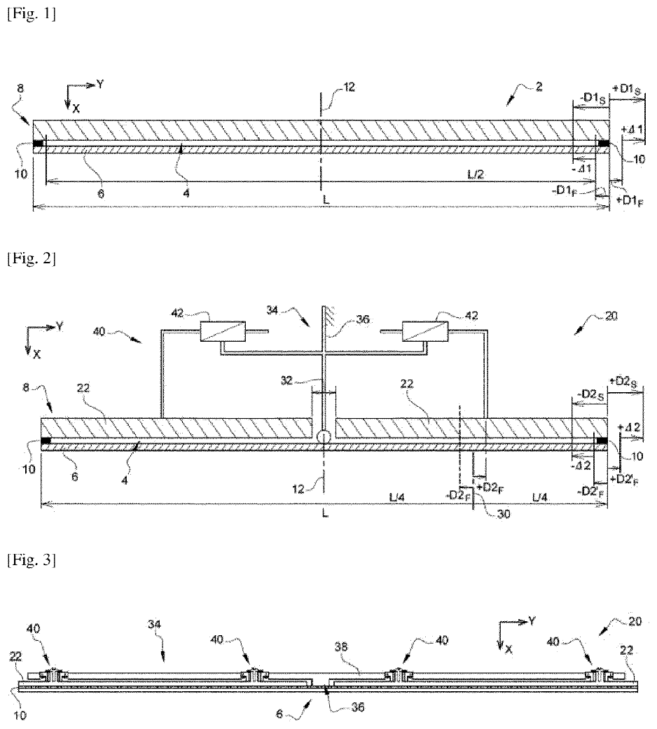

FIG. 1 is a schematic view of assembly according to the prior art, subjected to strong variations of temperature;

FIG. 2 is a simplified schematic representation of an assembly according to the invention, subjected to strong variations of temperature;

FIG. 3 is a schematic view in cross-section of the assembly according to a first embodiment;

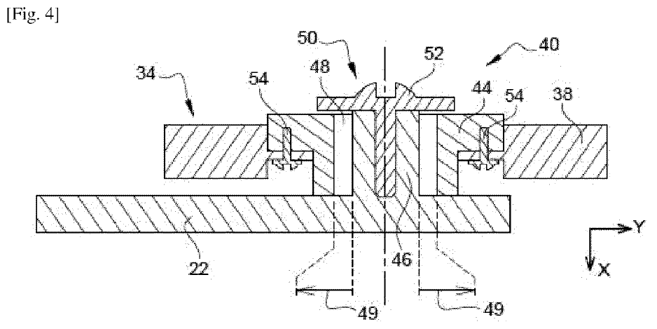

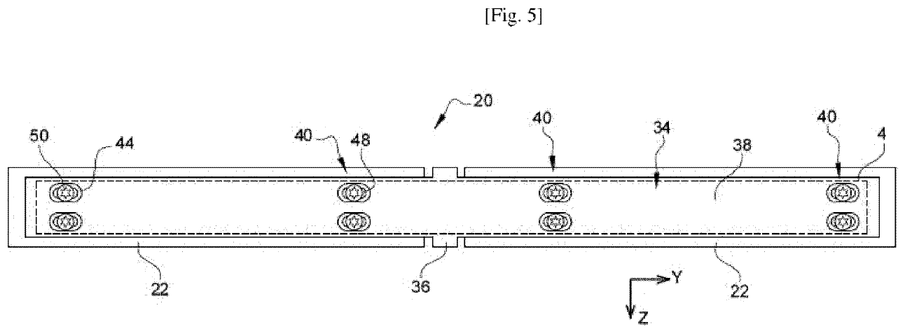

FIG. 4 is a schematic view in cross-section of the pivot-sliding connection device of the assembly of FIG. 3;

FIG. 5 is a view from above of the assembly according to the first embodiment of FIG. 3;

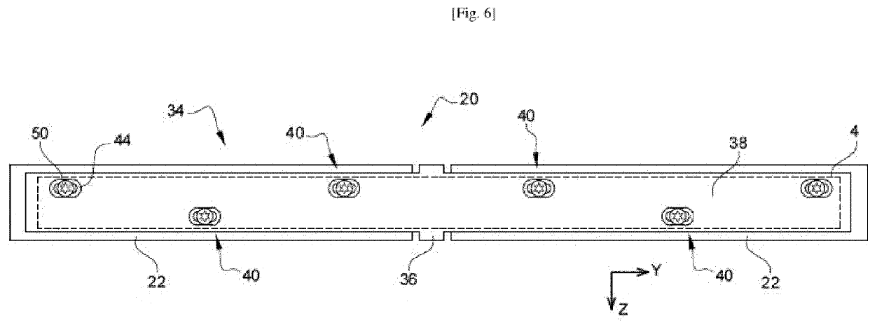

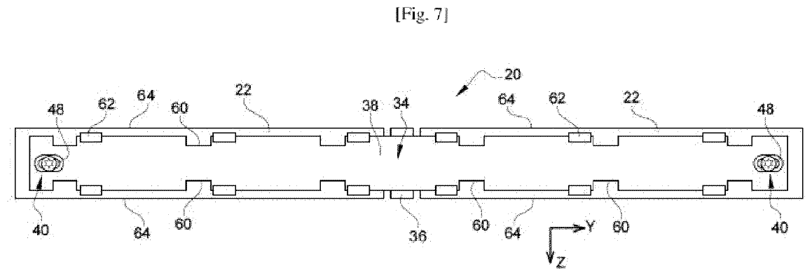

FIG. 6 is a view from above of the assembly according to the second embodiment;

FIG. 7 is a view from above of the assembly according to the third embodiment;

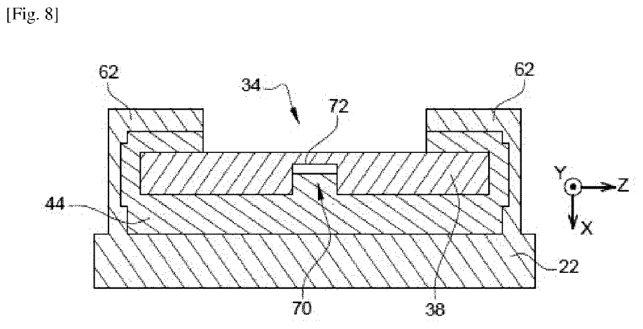

FIG. 8 is a view in transverse cross-section of the assembly according to one embodiment.

In these figures, the trihedron XYZ, as well as the references XY and YZ will represent the orientation of the connection systems according to the different embodiments. The longitudinal direction Y corresponds to the main direction of expansion of the assembly, i.e. the direction of the longest length of the assembly. The vertical X and transverse Z directions correspond to axes perpendicular to the longitudinal direction Y.

FIG. 1 represents an assembly 2 according to the prior art, designed to receive a display device 4. Said assembly 2 comprises:
a façade 6 which forms a plate and is made of glass, designed to be placed in front of said display device 4;
a support 8 which is made of magnesium alloy; and
a glue seal 10 which secures the façade 6 on the support 8.

The façade 6 is in a single piece, and is transparent, such that the image of the display device 4 can be seen through this façade 6.

The façade 6 has a rectangular form, with the large side of the rectangle extending in the main direction of expansion.

“The main direction of expansion of the assembly” means a particular direction in which the expansion or contraction of the different parts of the assembly 2 are measured. For example, the main direction of expansion is the direction with the longest length of the assembly 2, i.e. in the direction Y of the trihedron XYZ. It will be appreciated that the expansion can take place in other directions. Hereinafter, account is not taken of the expansions which take place in these directions other than the direction Y.

The display device 4 which the assembly 2 is designed to receive comprises a plurality of screens (not represented), with each screen comprising a panel of pixels (not represented). The size of the screens is 12.3 inches, with an image format of 8:3.

The screens are designed to extend along the entire width of an instrument panel of a vehicle (not represented). The width of an instrument panel of a vehicle measures approximately 1.2 m.

A case is considered in which the assembly 2 is subjected to variations of temperature in a range of −40 °C to +90 °C.

It is considered that, on the median plane 12 of the assembly 2, the displacement in the direction Y is zero (Y=0). Evaluations are made of the elongations of the façade D1_{F} and the support D1_{S} caused by the expansion starting from the median plane of the assembly 12, with the following formulae [Math. 1] and [Math. 2].

$$D {1}_{F} = \frac{L}{2} \times b \times Δ T \qquad [ Math . 1 ]$$

$$D {1}_{S} = \frac{L}{2} \times a \times Δ T \qquad [ Math . 2 ]$$

where: D1_{F} is the elongation or contraction of the façade starting from the median plane of the assembly 12 in millimeters;
D1_{S} is the elongation or contraction of the support 8 starting from the median plane of the assembly 12 in millimeters;
L is the length of the assembly 2 at the ambient temperature in millimeters;
a=27.10⁻⁶ °C⁻¹ is the coefficient of expansion of the magnesium alloy;
b=9.10⁻⁶ °C⁻¹ is the coefficient of expansion of the glass;
ΔT: is the temperature difference in °C.

The median plane of the façade 12 and the median plane of the assembly 12 are merged.

Since the coefficient of expansion of magnesium is three times greater than the coefficient of expansion of glass b, it is possible to carry out an approximation according to which the elongation of the assembly D1 corresponds to a maximum between D1_{S} and D1_{F}, and the elongation D1 is substantially equal to the elongation of the support D1_{S}, which gives the equation [Math. 3]:

$$D 1 = D {1}_{S} = \frac{L}{2} \times a \times Δ T \qquad [ Math . 3 ]$$

The differential elongation Δ1 corresponds to a difference in absolute value between the elongation of the support D1_{S} and the elongation of the façade D1_{F}.

$$Δ1 = \vert D {1}_{S} - D {1}_{F} \vert = ( \frac{L}{2} ) \times \vert ( a - b ) \times Δ T \vert \qquad [ Math . 4 ]$$

In this example, the length L of the assembly measures 1200 mm.

The difference of temperature ΔT is 65 °C.

The assembly is elongated or contracted on each side as follows, according to the equation [Math. 3]:

D1=D1_{S}=(1200/2)*27.10⁻⁶*65=1.05 mm

The differential elongation of each side according to the equation [Math. 4]: is

Δ1=(1200/2)*65*(27.10⁻⁶−9.10⁻⁶)=0.702 mm

Thus, the assembly 2 is contracted or elongated by 1.05 mm on each side, between −40 °C and +90 °C, in relation to its nominal length at 25 °C, and the glue seal 10 is subjected to shearing of 0.702 mm in one direction or the other, on each side, between −40 °C and +90 °C.

When the glue seal 10 does not have the capacity to absorb this shearing, this can lead either to its breakage, and thus deterioration of the assembly 2, or to behavior of flexure and/or curvature of the assembly 2 in the manner of a bi-metal strip.

In addition, the dimensional variation of the assembly 2 needs the instrument panel (not represented) to be able to absorb dimensional changes of this type, i.e. by providing substantial play between the assembly 2 and the elements which form said instrument panel. Otherwise, said elements of the instrument panel will be into contact with one another, and can be put under stress, which can give rise to damage, or at the least to friction noises and/or squeaking.

FIG. 2 is a simplified schematic representation of an assembly 20 according to the invention subjected to strong variations of temperature.

FIG. 2 shows a schematic representation of the assembly 20 according to the invention, designed to receive said display device 4 subjected to strong variations of temperature.

Said assembly 20 comprises:
a façade 6 forming a plate made of glass, designed to be placed in front of said display device 4;
a support 8 made of magnesium alloy, said support 8 being designed to support the façade 6, and said support 8 being formed by a succession of two portions of support 22 positioned in the direction Y; and
a glue seal 10 which secures the façade 6 on the portions of support 22.

“Succession of at least two portions of support 22” means the fact that these portions of support 22 are placed in the direction Y one after another. For example, these portions of support 22 are aligned in this direction Y.

The portions of support 22, which have dimensions identical to one another, face different parts of the façade 6, such that all the portions of support 22 together face this façade 6.

As illustrated in FIGS. 5 to 7, the two portions of support 22 are symmetrical with one another in relation to a plane of symmetry which intersects the direction Y perpendicularly, i.e. the direction Z. The two portions of support 22 are symmetrical with one another in relation to a median plane of symmetry 12 with the longest length of the façade 6, i.e. the direction Y.

The median plane of the façade 12 and the median plane of the assembly 12 are merged.

In the assembly according to the invention, account is taken of the median plane 30 of a portion of support 22 which is a quarter of the way along the length of the façade 6 in relation to the median plane 12 of the façade 6, and is displaced together with the façade 6 as the expansion of the façade 6 takes place.

Evaluation is carried out of the elongations of the façade D2_{F} and the support D2_{S} caused by the expansion with the following formulae [Math. 5] and [Math. 6].

$$D {2}_{F} = D {2}_{F}^{′} = \frac{L}{4} \times b \times Δ T \qquad [ Math . 5 ]$$

D2_{F} designates the displacement of the median plane of the portion of support 30 in relation to the median plane of the façade 12. This value D2_{F} corresponds to the expansion of the portion of façade 6 with a length L/4, in the temperature range ΔT.

D2′_{F} designates the displacement of the end of the façade 6 in relation to the median plane of the portion of support 30. This value D2′_{F} corresponds to the expansion of the portion of façade 6 with a length L/4, in the temperature range ΔT.

These two values D2_{F} and D2′_{F} are based on an identical length L/4, a single coefficient of expansion b, and a single temperature range ΔT. Thus these values D2_{F} and D2′_{F} are equal.

$$D {2}_{s} = \frac{L}{4} \times a \times Δ T \qquad [ Math . 6 ]$$

D2_{F} is the elongation or contraction of the façade 6 starting from the median plane of the façade 12 in millimeters;

D2_{S} is the elongation or contraction of the support 8 starting from the median plane of the portion of support 30 in millimeters;

The elongation of the assembly, known as D2, corresponds to the sum of the elongation of the façade 6 at the median plane of the façade D2_{F} and the elongation of the support D2_{S}. Thus, D2 is expressed as follows.

$$D 2 = D {2}_{F} + D {2}_{S} = ( \frac{L}{4} ) \times ( a + b ) \times Δ T \qquad [ Math . 7 ]$$

The differential elongation Δ2 corresponds to a difference in absolute value between the elongation of the support D2_{S} and of the façade D2′_{F}.

$$Δ2 = \vert {D2}_{S} - D {2}_{F}^{′} \vert = \vert ( \frac{L}{4} ) \times ( a - b ) \times Δ T \vert \qquad [ Math . 8 ]$$

In this example the length L of the assembly 20 measures 1200 mm.

The difference of temperature ΔT is 65 °C.

The assembly 20 is elongated or contracted on each side as follows according to the equation [Math. 7]:

D2=D2_{F}+D2_{S}=(1200/4)*65*(27.10⁻⁶+9.10⁻⁶)=0.702 mm

The differential elongation of each side according to the equation [Math. 8] is:

Δ2=(1200/4)*65*(27.10⁻⁶−9.10⁻⁶)=0.351 mm

The assembly 20 is contracted or elongated by 0.702 mm on each side, between −40 °C and +90 °C in relation to its nominal length at 25 °C.

The shearing of the glue seal 10 is 0.351 mm in one direction or the other, on each side, between −40 °C and +90 °C.

The invention makes it possible to bring the elongation of the assembly 20 to +/−0.702 mm on each side, in relation to the dimension at ambient temperature, throughout the total temperature range. In particular, the shearing of the glue seal 10 is brought to a maximal value of 0.351 mm in one direction or the other.

Thus, the shearing of the glue seal 10 is divided by half.

As can be seen in FIGS. 2 and 3, the portions of support 22 are positioned with a space 32 between one another in the direction Y.

Thus, the space 32 between the portions of support 22 makes it possible to prevent damage or friction noises or squeaking caused by any contact between the portions of support 22.

As illustrated in FIGS. 3 to 5, the assembly 20 comprises a metal cradle 34 which is designed to be secured in a rigid manner on the façade 6 by means of a glue seal 10.

“Secured rigidly” means the fact that there is no degree of freedom between the cradle 34 and the façade 6. The cradle 34 makes it possible to render the portions of support 22 integral, while leaving a degree of freedom in the direction Y, such as to allow the portions of support 22 to slide along the cradle 34 as the expansion takes place.

The cradle 34 comprises:
a securing element 36, which is situated on the median plane of symmetry of the façade 12 in the direction Y; and
a base 38 with a substantially rectangular periphery integral with the securing element, with said base 38 supporting the portions of support 22.

The securing element 36 permits referencing of the middle of the façade 6 in relation to the vehicle (not represented).

The façade 6 is secured on the portions of support 22 and on the securing element 36 of the cradle 34. The portions of support 22 are interposed between the cradle 34 and the façade 6.

The cradle base 38 supports the portions of support 22 with a degree of freedom which allows the portions of support 22 to slide in relation to the cradle 38 in the direction Y.

In the first embodiment of the invention, represented in FIGS. 3 to 5, the assembly 20 comprises a sliding connection for each of the proportions of support, with the sliding connection being configured to connect the cradle 34 and one of the two portions of support 22, such as to permit translation of said portion of support 22 in relation to the cradle 34 in the direction Y.

The rigidity of the assembly 20 is provided by the cradle 34. The cradle 34 renders the portions of support 22 integral, while leaving a degree of freedom, thanks to the sliding connections in the direction Y, such as to allow these portions of support 22 to slide along the cradle 34 as the expansion takes place.

Again in the first embodiment, the assembly comprises altogether eight pivot-sliding connection devices 40. Each portion of support 22 comprises four pivot-sliding connection devices 40. Each sliding connection of the portions of support 22 thus comprises four pivot-sliding connection devices associated in such a way as to maintain a degree of freedom in translation in the direction Y. These pivot-sliding connection devices 40 are positioned on the portions of support 22 symmetrically in relation to the median plane of symmetry of the façade 12.

These pivot-sliding connection devices 40 each comprise an immovable guiding element which is formed by a runner 44 embedded in the cradle base 38, and designed to cooperate with the portions of support 22. The runner 44 is rendered integral with the securing element 36 by being screwed into the cradle 34.

Thus, said runner 44 permits sliding along the direction Y.

Each portion of support 22 comprises four hollow small columns 46 extending along the axis X of the portion of support 22.

The runner 44 comprises an orifice 48 with a form which is oblong in the direction Y, designed to receive the small column 46 which can extend in said orifice 48.

The dimensions of the orifice 48 of the runner 44 are also selected such as to permit clearance 49 of the small columns 46 in the direction Y.

The runner 44 is made of polymer derived from tetra-fluoroethylene having a coefficient of friction which is low in relation to the coefficient of friction of the magnesium which forms the portions of support 22.

The pivot-sliding connection devices 40 each comprise a main blocking screw 50 extending along the axis X, and positioned in one of the hollow small columns 46 of the portion of support 22. The head 52 of the blocking screw 50 is wider than the orifice 48 of the runner 44.

The pivot-sliding connection devices 40 also each comprise two secondary blocking screws 54, which are embedded in the cradle base 38 and the runner 44 along the axis X, in the direction opposite the main blocking screw 50, such that the runner 44 is interposed between the main blocking screw 50 and the secondary blocking screws 54.

These secondary blocking screws 54 can be replaced by over-molding of the runner 44 on the cradle base 38.

By this means, the runner 44 is secured on the cradle base 38 in an optimal manner, as a result of the stresses applied in the two opposite directions by the main 50 and secondary 54 blocking screws.

In the example of FIG. 5, each portion of support 22 comprises four pivot-sliding connection devices 40 positioned at the four corners of an imaginary rectangle inscribed in this portion of support 22.

FIG. 6 shows a second embodiment of the invention. In this second embodiment, the pivot-sliding connection devices 40, the portions of support 22, and the cradle 34, are identical to those of the first embodiment. Only the arrangement of the pivot-sliding connection devices 40 differs from the first embodiment.

Each portion of support 22 is designed to cooperate with three pivot-sliding connection devices 40 positioned in an alternating manner in the direction Y.

FIG. 7 shows a third embodiment of the invention.

In this embodiment, the cradle base 38 comprises:
six notches 60 which are designed to permit the insertion of six hooks 62 belonging to each portion of support 22.

Two portions of support 22 thus comprise twelve notches 60 which permit the insertion of twelve hooks 62. The number of hooks and notches can be different from twelve.

These hooks 62 of the portion of support 22 are designed to render the portion of support 22 integral, while leaving a degree of freedom of translation in the direction Y, when the portion of support 22 is assembled with the cradle base 38.

In order to assemble the portion of support 22 on the cradle base 38, the hooks 62 are inserted in the notches 60, then the portion of support 22 is slid in relation to the cradle base 38, such that the hooks 62 are engaged with the cradle base 38, while leaving the degree of freedom of translation in the direction Y.

Said notches 60 are positioned on each lateral edge 64 of the cradle 34, said lateral edge 64 of the cradle 34 being parallel to the longest length of the cradle 34.

Again in the embodiment corresponding to FIG. 7, each portion of the support 22 comprises a pivot-sliding connection device 40 and six notches 62 positioned on two parallel lateral edges 64 of the portion of support 22, such as to maintain a degree of freedom in translation in the direction Y.

Each portion of support 22 comprises two stops in order to limit the displacement of the portion of support 22 in relation to the cradle base 38, while permitting a degree of translation with a value equal to, or greater than, the maximal expansion.

The stops corresponding to the ends of the oblong orifices 48 are formed on the pivot-sliding connection device 40.

According to one embodiment illustrated in FIG. 8, the assembly 20 comprises a runner 44 interposed between the hooks 62 and the portions of support 22, such that the cradle 34 can slide in the direction Y, between the hooks 62 and the portions of support 22, with less friction. The runner 44 is integral with the proportions of support 22.

The runner 44 comprises a guiding rib 70 situated on the plane of axial symmetry with the longest length of the runner 44, and designed to cooperate with a groove of the cradle 72, with said rib 70 extending in the direction Y.

The guiding rib 70 allows one of the portions of support 22 to slide in the direction Y along the cradle as the thermal expansion takes place.

1. An assembly for receiving at least one display device, comprising:
a façade made of a glass material with a first coefficient of expansion, which is designed to be placed in front of the display device;
a support made of a metal material with a second coefficient of expansion, the second coefficient of expansion being higher than the first coefficient of expansion, the support being designed to support the façade, and the support being formed by a succession of at least two portions of support positioned in a main direction of expansion of the assembly; and
at least one adhesive which secures the façade on the at least two portions of support (22).

2. The assembly as claimed in claim 1, comprising a cradle made of metal, which is designed to be secured in a rigid manner on the façade by means of the at least one adhesive.

3. The assembly as claimed in claim 2, wherein the cradle comprises:
a securing element which is designed to be secured on the façade; and
a base which is integral with the securing element, with the base (38) supporting the at least two portions of support.

4. The assembly as claimed in claim 2, comprising at least one sliding connection which is configured to connect the cradle and one of the portions of support, such as to permit translation of the portion of support with respect to the cradle in the main direction of expansion.

5. The assembly as claimed in claim 1, comprising at least one pivot-sliding connection comprising a guiding element which is designed to cooperate with one of the portions of support.

6. The assembly as claimed in claim 5, wherein each sliding connection comprises at least two pivot-sliding connection devices which are associated in such a way as to maintain a degree of freedom in translation in the main direction of expansion.

7. The assembly as claimed in claim 5, wherein each portion of support comprises at least two pivot-sliding connection devices which are spaced from one another in the main direction of expansion of the assembly.

8. The assembly as claimed in claim 5, wherein each portion of support comprises at least two pivot-sliding connection devices which are offset from one another on an axis transverse to the main direction of expansion of each portion of support.

9. The assembly as claimed in claim 3, wherein the base comprises:
a plurality of notches, designed to permit the insertion of hooks belonging to one of the portions of support; and
the hooks of the portion of support being designed to render the portion of support integral with the base, while leaving a degree of freedom of translation in the main direction of expansion, when the portion of support is assembled with the base.

10. The assembly as claimed in claim 9, wherein each sliding connection comprises a pivot-sliding connection device and at least two hooks positioned on two parallel lateral edges of the portion of support, such as to maintain a degree of freedom in translation in the main direction of expansion.

11. A vehicle instrument panel, comprising an assembly as claimed in claim 1, and a display device positioned facing the façade of the assembly.
